(19) United States
(12) Patent Application Publication
(10) Pub. No.: US 2006/0093805 A1
(43) Pub. Date: May 4, 2006

(54) Dielectric constant adjustable resin composition, prepreg and copper clad laminate utilizing the same

(75) Inventors: Chien-Ting Lin, Hsinchu (TW); Kuo-Yuan Hsu, Miaoli Hsien (TW)

Correspondence Address: BIRCH STEWART KOLASCH & BIRCH, PO BOX 747, FALLS CHURCH, VA, 22040-0747, US

(73) Assignees: INDUSTRIAL TECHNOLOGY RESEARCH INSTITUTE; Advance Materials Corporation

(21) Appl. No.: 11/212,737

(22) Filed: Aug. 29, 2005

(30) Foreign Application Priority Data
Oct. 28, 2004 (TW) 93132692

(51) Int. Cl. B32B 25/02

(52) U.S. Cl. 428/295.1

(57) ABSTRACT

The present invention provides a dielectric constant adjustable resin composition, a pre-preg, and a copper clad laminate utilizing. The dielectric constant adjustable resin composition includes a curable polyphenylene ether (PPE) resin, a curing agent, a free radical initiator, and a dielectric ceramic powder with a particle size of 0.1 to 2 m um modified with a lipophilic modifier.

### BACKGROUND

1. Field of the Invention

The present invention relates to a dielectric constant adjustable resin composition, a pre-preg, and a copper clad laminate. More particularly, the present invention relates to a resin with increased dielectric constant, thermal stability and reduced dissipation constant.

2. Description of the Prior Art

Communication devices tend to function at higher speeds and frequencies. The substrate material for such devices, such as wireless communication networks, satellite communication equipment, high performance and broadband devices, high speed computers and computer work stations, demands a high glass transition temperature (Tg), low dielectric constant (Dk), and low loss factor (Df). Presently, the copper-clad laminate used for printed circuit boards (PCB) is mainly FR-4, the substrate of which is epoxy resin. However, electrical properties (such as Dk and Df) of FR-4 can no longer meet the increasing needs of high frequency.

Polyphenylene ether (PPE), having high Tg and superior electrical properties, is a potential material for high frequency substrates. However, PPE is a thermoplastic resin and provides poor solvent resistance. Therefore, there is a need to modify PPE into a thermosetting resin to increase solvent resistance and heat resistance.

In order to provide the Bluetooth module substrate material with an increased dielectric constant and a reduced dissipation constant to achieve the need of a buried wave filter, in addition to the described thermosetting resin requirement, the field urgently needs a resin with an increased dielectric constant, and a reduced dissipation constant.

### SUMMARY

An object of the present invention is to provide a dielectric constant adjustable resin composition to form a thermosetting resin with increased dielectric constant, and reduced dissipation constant.

Another object of the present invention is to provide a dielectric constant adjustable resin composition comprising small particle size dielectric ceramic powder modified with a lipophilic modifier with improved adhesion between the pre-preg formed of the resin composition and the cupper foil of the copper-clad laminate.

In one embodiment, the dielectric constant adjustable resin composition of the present invention includes:

(a) a curable polyphenylene ether resin represented by formula (I), 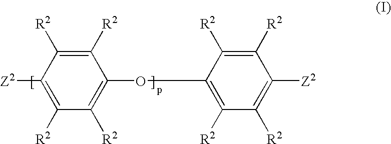
wherein

each of R² can be the same or different and is H, alkyl having 1 to 3 carbon atoms, 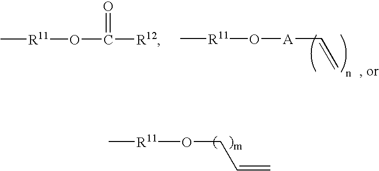
wherein

R¹¹ is alkylene having 1 to 3 carbon atoms;

R¹² is aryl;

A is selected from the group consisting of C₁₋₈ ethers, C₁₋₈ amines, C₁₋₈ amides, and C₁₋₈ esters;

n is 1 or 2; and

m is an integer of from 0 to 6;
each of Z² can be the same or different and is H, OH, 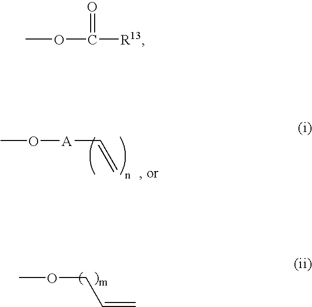
and at least one Z² is the functional group represented by formula (i) or (ii), wherein R¹³ is aryl, and A, n, m are defined as above;

p is an integer from 2 to 165.

(b) 5 wt % to 50 wt % of a curing agent, based on the total weight of the resin;

(c) 0.01 wt % to 5 wt % of a free radical initiator, based on the total weight of the resin;

(d) 5 wt % to 60 wt % of a dielectric ceramic powder with a particle size of 0.1 to 2 μm and a dielectric constant (Dk) of 10 to 20000, based on the total weight of the resin.

In another embodiment, the dielectric constant adjustable resin composition of the present invention includes:

(a) a curable polyphenylene as above;

(b) 5 wt % to 50 wt % of a curing agent, based on the total weight of the resin;

(c) 0.01 wt % to 5 wt % of a free radical initiator, based on the total weight of the resin; and

(d) 5 wt % to 60 wt % of a dielectric ceramic powder with a surface modified with a lipophilic modifier.

The invention also provides a pre-preg, comprising:

(a) a dielectric constant adjustable resin composition as set forth above; and

(b) a reinforcing material impregnated with the resin composition.

The invention also provides a copper-clad laminate, comprising:

(a) a pre-preg as set forth above; and

(b) a copper foil bonded onto the pre-preg by compression molding.

### DETAILED DESCRIPTION

The present invention provides a dielectric constant adjustable resin composition, including:

(a) a curable polyphenylene ether resin represented by formula (I), 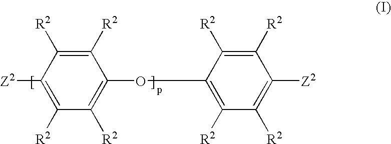
wherein

each of R² can be the same or different and is H, alkyl having 1 to 3 carbon atoms, 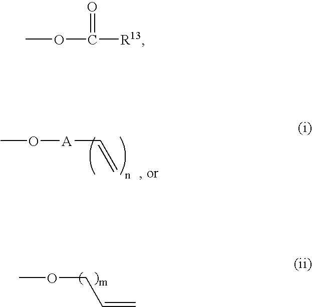
wherein

R¹¹ is alkylene having 1 to 3 carbon atoms;

R¹² is aryl;

A is C₁₋₈ ethers, C₁₋₈ amines, C₁₋₈ amides, or C₁₋₈ esters;

n is 1 or 2; and

m is an integer of from 0 to 6;
each of Z² can be the same or different and is H, OH, 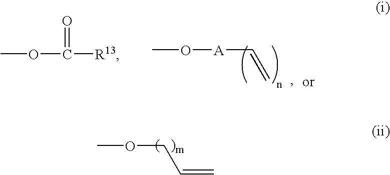
and at least one Z² is the functional group represented by formula (i) or (ii), wherein R¹³ is aryl, and A, n, m are defined as above;

p is an integer from 2 to 165.

(b) 5 wt % to 50 wt % of a curing agent, based on the total weight of the resin;

(c) 0.01 wt % to 5 wt % of a free radical initiator, based on the total weight of the resin; and

(d) 5 wt % to 60 wt % of a dielectric ceramic powder with a particle size of 0.1 to 2 μm and a dielectric constant(Dk) of 10 to 20000, based on the total weight of the resin.

In accordance with the present invention, the curable polyphenylene ether(PPE) resin is disclosed in U.S. Pat. No. 6,693,149, which is incorporated herein by reference in its entinety. The PPE dielectric constant(Dk) is above 4.5 at 1 GHz, 6 to 10 at 1 to 3.4 GHz and the dissipation constant is below 0.008 GHz at 1 GHz, 0.004 to 0.015 GHz at 1 to 3.4 GHz.

The dielectric ceramic powder with a particle size of 0.1 to 2 m um may be employed to avoid precipitation from varnish due to oversize or overweight. As the smaller powder particle has larger surface area, it has larger resistance to precipitate from varnish. Accordingly, the varnish of the invention has better storage stability.

In accordance with the present invention, the dielectric ceramic powder is perovskite and may be barium titanate (BaTiO) or lead titanate (PbTiO3). The free radical initiator suitable for use in the present invention includes 2,5-dimethyl-2,5-di-tert-butylperoxy-hexane (DHBP), di-tert-butylperoxide (DTBP), di-cumylperoxide (DCP), benzoylperoxide (BPO), 1,3-di(2-tert-butylperoxy isopropyl)benzene (DIPP), and 2,5-dimethyl-2,5-di-tert-butylperoxy-hexyne (DYBP).

The curing agent suitable for use in the present invention includes triallyl isocyanurate (TAIC) and triallyl cyanurate (TAC).

The composition of the present invention can further comprise 1 wt % to 50 wt % of a flame retardant, based on the total weight of the composition. The flame retardant can be phosphorus-containing flame retardant, chlorine-containing flame retardant, bromine-containing flame retardant, nitrogen-containing flame retardant, oxides of antimony, aluminum hydroxide, magnesium hydroxide, or mixtures thereof. A representative example of the bromine-containing flame retardant is N1,N1-diallyl-2-[2,6-dibromo-4-(2-{3,5-dibromo-4-[(dially lcarbamoyl)methoxy]phenyl}-1,1-dimethylethyl)phenoxy]acet amide.

The present invention also provides a dielectric constant adjustable resin composition, including:

(a) a curable polyphenylene as above;

(b) 5 wt % to 50 wt % of a curing agent, based on the total weight of the resin;

(c) 0.01 wt % to 5 wt % of a free radical initiator, based on the total weight of the resin; and

(d) 5 wt % to 60 wt % of a dielectric ceramic powder with a surface modified with a lipophilic modifier.

The lipophilic modifier used in the present invention includes vinyl triacetoxy, silane vinyl trichloro silane, vinyl triethoxy silane, vinyl trimethoxy silane, vinyl tris(b-methoxy ethoxy)silane, γ-methacryloxy propyl trimethoxy silane, γ-methacryloxy propyl tris-(b-methoxy ethoxy) silane, and mixtures thereof. The modifying process includes a modifier first dissolved in an aqueous methanol or ethanol solution, and a dielectric ceramic powder then added thereto. The liquid part of the solution was removed by heating with stirring, and the solid dielectric ceramic powder was dried in oven at 120° C.

According to the present invention, the above dielectric constant adjustable resin composition may have a high dielectric constant of above 4.5 and at low dissipation constant of below 0.008 GHz. Accordingly, the substrate made therefrom is particularly suited for bluetooth applications.

According to the present invention, the above components of the resin composition are dissolved in a solvent and mixed thoroughly to form a varnish. Then, a reinforcing material, such as paper or glass cloth, was impregnated in the varnish. After drying, a pre-preg was thus formed.

The above pre-preg may be bonded to a copper foil by compression molding to form a copper-clad laminate. The adhesion between the pre-preg and the cupper foil may be as high as 14N/cm. Such a copper-clad laminate has high strength, increased dielectric constant, thermal stability and reduced dissipation constant, meeting the requirements for buried wave filters.

The following examples are intended to illustrate the process and the advantages of the present invention more fully without limiting its scope, since numerous modifications and variations will be apparent to those skilled in the art.

### EXAMPLE 1

### Dielectric Constant Adjustable Resin Composition

8 g of ANCO-rPPE (disclosed in U.S. Pat. No. 6,693,149), 0.3 g of DHBP (a free radical initiator), and 2 g of TAIC (a curing agent) were dissolved in 20 ml of toluene, then 21 g of BT260 (Fuji Titanium Industry Co. Ltd., dielectric constant=22000, dissipation constant=0.014, particle size=1.58 μm) were added, and mixed thoroughly to form a varnish. The varnish was dried to remove toluene and then subjected to press molding under a pressure of 20 kg/cm² at 200° C. for 1 hour. The obtained resin sheet had good appearance and was not soluble in toluene or dichloromethane. The resin sheet was evaluated for dielectric properties using a dielectric analyzer (HP 4291B). The results listed in Table 1 were: Dk=11(1 GHz), Dissipation constant=0.008.

### EXAMPLE 2

### Dielectric Constant Adjustable Resin Composition

The same procedure as described in example 1 was repeated except that the BT260 was replaced with ST222R(Fuji Titanium Industry Co. Ltd., dielectric constant=2270, dissipation constant=0.0004, particle size=0.86 μm). The results listed in Table 1 were: Dk=9.8(1 GHz), Dissipation constant=0.015.

### EXAMPLE 3

### Dielectric Constant Adjustable Resin Composition

10 g of ATBPA was added into 20 ml of toluene, then mixed thoroughly for 0.5 minutes, and 80 g of COG820MW (dielectric ceramic powder, manufactured by Ferro Electronic Materials) was added with stir to form a white varnish. 40 g of ANCO-rPPE dissolved in 50 g of 80 to 90° C. toluene, then COG820MW added and stirred when the solvent cooled to room temperature. 6 g of TAIC and 1.7 of DHBP were added to the mixing solution and stirred to form a varnish. The varnish was dried to remove toluene and then subjected to press molding under a pressure of 20 kg/cm² at 200° C. for 1 hour. The obtained resin sheet had good appearance and was not soluble in toluene or dichloromethane. The resin sheet was evaluated for dielectric properties by using a dielectric analyzer (HP 4291B). The results listed in Table 1 were: Dk=5.2(1 GHz), 6.7(2.1 GHz), 6.8(3.4 GHz); Dissipation constant=0.004 (1 GHz), 0.008(2.1 GHz), 0.007(3.4 GHz).

### EXAMPLE 4

### Dielectric Constant Adjustable Resin Composition

The same procedure as described in example 3 was repeated except that the weight of COG820MW was increased to 130 g. The results listed in Table 1 were: Dk=6.7(1 GHz), 8.9(2.1 GHz), 8.9(3.4 GHz); Dissipation constant=0.005(1 GHz), 0.008(2.1 GHz), 0.006(3.4 GHz).

### EXAMPLE 5

### Dielectric Constant Adjustable Resin Composition

The same procedure as described in example 3 was repeated except that the 80 g of COG820MW was replaced by 160 g of COG350H(dielectric ceramic powder, manufactured by Ferro Electronic Materials). The results listed in Table 1 were: Dk=6.2(1 GHz), 7.9(2.1 GHz), 7.9(3.4 GHz); Dissipation constant=0.007(1 GHz), 0.005(2.1 GHz), 0.005(3.4 GHz).

### EXAMPLE 6

### Pre-Preg and Copper-Clad Laminate for Printed Circuit Board

22 g of ANCO-rPPE (F), 0.825 g of DHBP, and 5.5 g of TAIC were dissolved in 25 g of toluene and mixed thoroughly to form a varnish. Glass cloth was impregnated in the varnish and then removed to dry at 120° C. for 5 minutes. A pre-preg with good appearance was obtained. Twelve sheets of the pre-pregs were stacked with two copper foils placed on and under the pre-pregs separately. The fourteen-layer structure was then subjected to press molding under a pressure of 5 kg/cm² at 200° C. for 1 hour. The copper-clad laminate obtained had good appearance and was not soluble in toluene or dichloromethane.

TABLE 1

| | Sample No | | | | |
|---|---|---|---|---|---|
| | 1 | 2 | 3 | 4 | 5 |
| F-PPE | 8 | 8 | 40 | 40 | 40 |
| TAIC | 2 | 2 | 6 | 6 | 6 |
| ATBPA | 0 | 0 | 10 | 10 | 10 |
| DCP/DHBP | 0.3 | 0.3 | 1.7 | 1.7 | 1.7 |
| Dielectric ceramic powder/g | BT206/21 | ST222R/21 | COG820MW/80 | COG820MW/130 | COG350H/160 |
| Dk | 11 (1 GHz) | 9.8 (1 GHz) | 5.2(1 GHz) | 6.7(1 GHz) | 6.2(1 GHz) |
| | | | 6.7(2.1 GHz) | 8.9(2.1 GHz) | 7.9(2.1 GHz) |
| | | | 6.8(3.4 GHz) | 8.9(3.4 GHz) | 7.9(3.4 GHz) |
| Dissipation constant | 0.008 (1 GHz) | 0.015 (1 GHz) | 0.004(1 GHz) | 0.005(1 GHz) | 0.007(1 GHz) |
| | | | 0.008(2.1 GHz) | 0.008(2.1 GHz) | 0.005(2.1 GHz) |
| | | | 0.007(3.4 GHz) | 0.006(3.4 GHz) | 0.005(3.4 GHz) |

The foregoing description of the preferred embodiments of this invention has been presented for purposes of illustration and description. Obvious modifications or variations are possible in light of the above teaching. The embodiments chosen and described provide an excellent illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. A dielectric constant adjustable resin composition, comprising:
(a) a curable polyphenylene ether resin represented by formula (I), 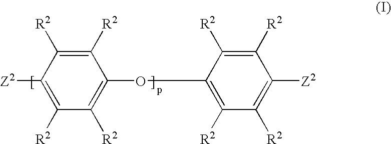
wherein
each of R² can be the same or different and is H, alkyl having 1 to 3 carbon atoms, 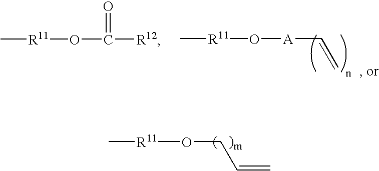
wherein
R¹¹ is alkylene having 1 to 3 carbon atoms;
R¹² is aryl;
A is C₁₋₈ ethers, C₁₋₈ amines, C₁₋₈ amides, and C₁₋₈ esters;
n is 1 or 2; and
m is an integer from 0 to 6;
each Z² can be the same or different and is H, OH, 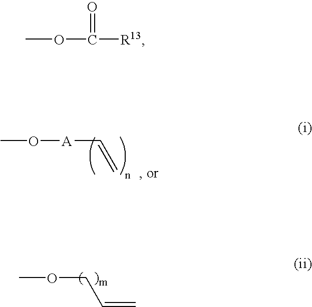
and at least one Z² is the functional group represented by formula (i) or (ii), wherein R¹³ is aryl, and A, n, m are defined as above;
p is an integer from 2 to 165.
(b) 5 wt % to 50 wt % of a curing agent, based on the total weight of the resin;
(c) 0.01 wt % to 5 wt % of a free radical initiator, based on the total weight of the resin; and
(d) 5 wt % to 60 wt % of a dielectric ceramic powder with a particle size of 0.1 to 2 μm and a dielectric constant(Dk) of 10 to 20000, based on the total weight of the resin.

2. The composition as claimed in claim 1, wherein the dielectric ceramic powder is perovskite.

3. The composition as claimed in claim 1, wherein the dielectric ceramic powder is barium titanate (BaTiO) or lead titanate (PbTiO3).

4. The composition as claimed in claim 1, wherein the curing agent is triallyl isocyanurate (TAIC) or triallyl cyanurate (TAC).

5. The composition as claimed in claim 1, wherein the free radical initiator is 2,5-dimethyl-2,5-di-tert-butylperoxy-hexane (DHBP), di-tert-butylperoxide (DTBP), di-cumylperoxide (DCP), benzoylperoxide (BPO), 1,3-di(2-tert-butylperoxy isopropyl)benzene (DIPP), or 2,5-dimethyl-2,5-di-tert-butylperoxy-hexyne (DYBP).

6. The composition as claimed in claim 1, further comprising 1 wt % to 50 wt % of a flame retardant, based on the total weight of the composition.

7. The composition as claimed in claim 6, wherein the flame retardant is phosphorus-containing flame retardant, chlorine-containing flame retardant, bromine-containing flame retardant, nitrogen-containing flame retardant, oxides of antimony, aluminum hydroxide, magnesium hydroxide, or mixtures thereof.

8. The composition as claimed in claim 1, wherein the resin composition further comprises a toluene varnish.

9. The composition as claimed in claim 1, wherein the dielectric constant (Dk) of the dielectric constant adjustable resin composition is above 6 at 1 GHz.

10. The composition as claimed in claim 1, wherein the dissipation constant of the dielectric constant adjustable resin composition is below 0.008 GHz at 1 GHz.

11. A dielectric constant adjustable resin composition, comprising:
(a) a curable polyphenylene as claimed in claim 1;
(b) 5 wt % to 50 wt % of a curing agent, based on the total weight of the resin;
(c) 0.01 wt % to 5 wt % of a free radical initiator, based on the total weight of the resin; and
(d) 5 wt % to 60 wt % of a dielectric ceramic powder with a surface modified with a lipophilic modifier.

12. The composition as claimed in claim 11, wherein the particle size of the dielectric ceramic powder is 0.1 to 2 um and the dielectric constant(Dk) is 10 to 20000.

13. The composition as claimed in claim 11, wherein the lipophilic modifier of the dielectric ceramic powder is vinyl triacetoxy, silane vinyl trichloro silane, vinyl triethoxy silane, vinyl trimethoxy silane, vinyl tris(b-methoxy ethoxy)silane, γ-methacryloxy propyl trimethoxy silane, γ-methacryloxy propyl tris-(b-methoxy ethoxy) silane, or mixtures thereof.

14. The composition as claimed in claim 11, wherein the dielectric constant (Dk) of the dielectric constant adjustable resin composition is above 6 at 1 GHz.

15. The composition as claimed in claim 10, wherein the dissipation constant of the dielectric constant adjustable resin composition is below 0.008 GHz at 1 GHz.

16. A pre-preg, comprising:
(a) a dielectric constant adjustable resin composition as set forth in claim 1; and
(b) a reinforcing material impregnated with the resin composition.

17. The pre-preg as claimed in claim 16, wherein the reinforcing material is paper or glass cloth.

18. A copper-clad laminate, comprising:
(a) a pre-preg as set forth in claim 16; and
(b) a copper foil bonded onto the pre-preg by compression molding.

19. The copper-clad laminate as claimed in claim 18, wherein the adhesion between the pre-preg and the cupper foil is about 14N/cm.
